(19) United States
(12) Patent Application Publication
(10) Pub. No.: US 2026/0312521 A1
(43) Pub. Date: Oct. 8, 2026

(54) MOTOR CONTROL DEVICE AND MOTOR CONTROL METHOD

(71) Applicant: Minebea Power Semiconductor Device Inc., Hitachi-shi, Ibaraki (JP)

(72) Inventors: Kosuke MATSUO, Tokyo (JP); Takahiro SUZUKI, Tokyo (JP); Dongsheng LI, Tokyo (JP); Tomohiro SUGINO, Hitachi-shi (JP)

(21) Appl. No.: 19/481,580

(22) PCT Filed: Jan. 31, 2024
(86) PCT No.: PCT/JP2024/003031

§ 371 Date: Nov. 5, 2025

(30) Foreign Application Priority Data
May 18, 2023 (JP) 2023-082215

(51) Int. Cl. H02P 21/26; H02P 21/22

(52) U.S. Cl. CPC H02P 21/26; H02P 21/22

(57) ABSTRACT

A motor control device controls operation of a permanent magnet synchronous motor by controlling an operation of an inverter according to a control signal based on a voltage command. A control unit of the control device generates a control signal of the inverter when the motor is idling by outputting a voltage command for causing a DC current having a predetermined initial value to flow through the motor. The control unit calculates a position and a rotation speed of a rotor of the motor based on the voltage command and a current value corresponding to the voltage command, and estimates an induced voltage of the motor based on the calculated rotation speed. The control unit adjusts the voltage command so as to be larger than the estimated induced voltage. As a result, the position and speed of the motor rotor can be calculated with higher accuracy.

### TECHNICAL FIELD

The present invention relates to a motor control device and a motor control method.

### BACKGROUND ART

In the fields of home electric appliances and industrial equipment, a motor drive system including an inverter that converts DC power into AC power and a permanent magnet synchronous motor has been widely used. In order to drive such a permanent magnet synchronous motor with high efficiency, information on the position of the rotor of the motor is generally required. The position of the rotor of the motor can be directly detected by using a position detector such as an encoder, but this has problems in terms of cost and reliability. Therefore, in recent years, position sensorless control, in which a position of a rotor of a permanent magnet synchronous motor is detected without using a position detector, has been proposed and applied to various products.

On the other hand, one of the known problems in the position sensorless control of the permanent magnet synchronous motor involves a method of restarting the permanent magnet synchronous motor from an idling state of the rotor (referred to as “free run start-up”). For example, a motor of a washing machine or the like may already be rotating before startup due to inertia of the load.

In this case, if there is no information on the position, the rotation speed, the rotation direction, and the like of the rotor in the idling state, it is necessary to wait until the motor stops, or to forcibly apply brake control to stop the rotation and restart the motor after the motor enters the stop state. Therefore, it takes a long time to restart the motor.

Therefore, for example, as in the conventional techniques described in PTL 1 and PTL 2, it has been developed that, focusing on an induced voltage generated when a permanent magnet synchronous motor is idling, a motor winding is short-circuited by an inverter, and a position and the like of a rotor are estimated based on a current flowing at this time.

In PTL 1, three upper (lower) arm elements among switching elements constituting the motor driving inverter are simultaneously turned on to cause a short-circuit current to flow through the motor windings, and a position and a rotation speed of the rotor are calculated based on detection information on three-phase motor currents.

In addition, in PTL 2, different arm elements for two phases of the motor driving inverter are simultaneously turned on and off to detect a bus (shunt) current on the DC side of the inverter, and a position and a rotation speed of the rotor of the motor are calculated.

### CITATION LIST

### Patent Literature

PTL 1: JP 2015-73361 A

PTL 2: JP 2018-170928 A

### SUMMARY OF INVENTION

### Technical Problem

However, the above-described conventional techniques have the following problems.

In the conventional technique described in PTL 1, since the short-circuit current of the motor winding during the short-circuit operation of the inverter is determined by the motor induced voltage, the winding resistance, and the inductance, an overcurrent may occur during the short-circuit operation depending on the idling speed.

In the conventional technique described in PTL 2, since a special PWM control mode and a current detection processing are used by detecting a current flowing through the bus (shunt) resistor, computation for calculating a position and a rotation speed of the rotor of the motor is complicated, and an error is likely to occur in the estimation result.

The present invention has been made in view of the above, and an object of the present invention is to provide a motor control device and a motor control method capable of calculating a position and a speed of a motor rotor with higher accuracy.

### Solution to Problem

The present application includes a plurality of means for solving the aforementioned problems, and an example thereof is a motor control device that controls an operation of a permanent magnet synchronous motor by controlling an operation of an inverter that converts DC power into AC power and supplies the AC power to the permanent magnet synchronous motor according to a control signal based on a voltage command, the motor control device including: a first control unit that generates a control signal of the inverter when the permanent magnet synchronous motor is normally operating; and a second control unit that generates a control signal of the inverter when the permanent magnet synchronous motor is idling, in which the second control unit is configured to: when the permanent magnet synchronous motor is in an idling state, output a voltage command for causing a DC current having a predetermined initial value to flow through the permanent magnet synchronous motor; calculate a position and a rotation speed of a rotor of the permanent magnet synchronous motor based on the voltage command and a current value of the permanent magnet synchronous motor corresponding to the voltage command; estimate an induced voltage of the permanent magnet synchronous motor based on the calculated rotation speed; and adjust the voltage command so as to be larger than the estimated induced voltage.

### Advantageous Effects of Invention

According to the present invention, the position and speed of the motor rotor can be calculated with higher accuracy.

### BRIEF DESCRIPTION OF DRAWINGS

FIG. 1 is a diagram schematically illustrating an overall configuration of a motor control system, together with a motor control device and its related configuration.

FIG. 2 is a functional block diagram illustrating processing details of the motor control device.

FIG. 3 is an explanatory diagram illustrating a current vector when a DC current flows through a permanent magnet synchronous motor.

FIG. 4 is a functional block diagram illustrating processing details of an idling state estimation unit.

FIG. 5 is a functional block diagram illustrating processing details of a voltage command generation unit.

### DESCRIPTION OF EMBODIMENT

Hereinafter, an embodiment of the present invention will be described with reference to the drawings. In the following description, a permanent magnet synchronous motor (PMSM) will be described as an example of a control target of a motor control device.

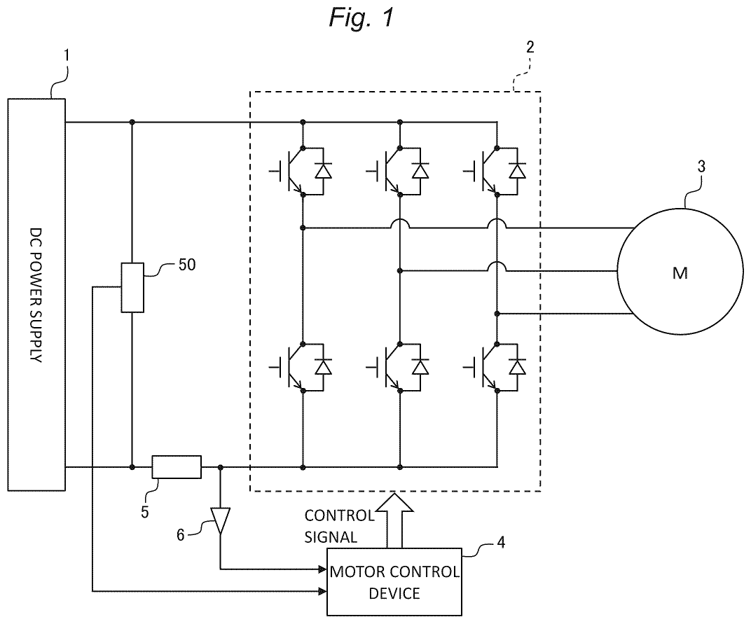

FIG. 1 is a diagram schematically illustrating an overall configuration of a motor control system according to the present embodiment, together with a motor control device and its related configuration.

As illustrated in FIG. 1, a motor control device 4 controls an operation of a permanent magnet synchronous motor 3 by controlling an inverter 2 that converts DC power from a DC power supply 1 into AC power and supplies the AC power to the permanent magnet synchronous motor 3 to be driven. As the motor control device 4, for example, a semiconductor arithmetic device such as a microcomputer or a digital signal processor (DSP) is used.

As the DC power supply 1, for example, a power conversion device (e.g., a diode rectifier, a stabilizing power supply, or the like) that converts AC power received from an AC power supply such as a commercial AC power supply (not illustrated) into DC power, a battery, or the like is used.

The inverter 2 is configured by connecting two arm circuits to which semiconductor switching elements (IGBTs, MOSFETs, or the like) and diodes are connected in anti-parallel, in other words, series-connected circuits in which an upper arm and a lower arm are connected in series, between a pair of positive and negative terminals of the DC power supply 1. The inverter 2 includes as many series-connected circuits as the number of output AC phases, and is, for example, a three-phase inverter including series-connected circuits for three phases in the present embodiment. The upper arm and the lower arm of the inverter 2 are connected to the high potential side and the low potential side of the DC power supply 1, respectively. A series connection point between the upper arm and the lower arm is connected to an AC terminal, and the permanent magnet synchronous motor 3 is connected to the AC terminal.

A low potential side bus of the inverter 2 is connected to the negative terminal of the DC power supply 1 via a shunt resistor 5 for current detection. A current detection signal detected by the shunt resistor 5 is input to the motor control device 4 via an amplifier 6. The signal output from the amplifier 6 to the motor control device 4 is converted into a digital signal by a sampling and hold circuit, an A/D converter, and the like (not illustrated) for digital calculation in the motor control device 4. That is, the shunt resistor 5 and the amplifier 6 constitute a DC current detector that detects a DC current flowing through the low potential side bus of the inverter 2 and outputs a current detection signal to the motor control device 4. Another current detection means such as a current sensor may be used instead of the shunt resistor 5.

In the inverter 2, a DC voltage detector 50 that detects a DC voltage between the high potential side bus and the low potential side bus and outputs a DC voltage detection signal to the motor control device 4 is installed between the high potential side bus connected to the positive terminal of the DC power supply 1 and the bus connected to the negative terminal of the DC power supply 1. The signal output from the DC voltage detector 50 to the motor control device 4 is converted into a digital signal, similarly to the DC current detector.

In the present embodiment, as will be described later, the motor control device 4 performs so-called position sensorless control in which a position of a rotor of the permanent magnet synchronous motor is detected without using a position detector to perform synchronization, and the permanent magnet synchronous motor 3 does not include a magnetic pole position detection means such as a Hall element that detects a position of a rotor or a rotation shaft.

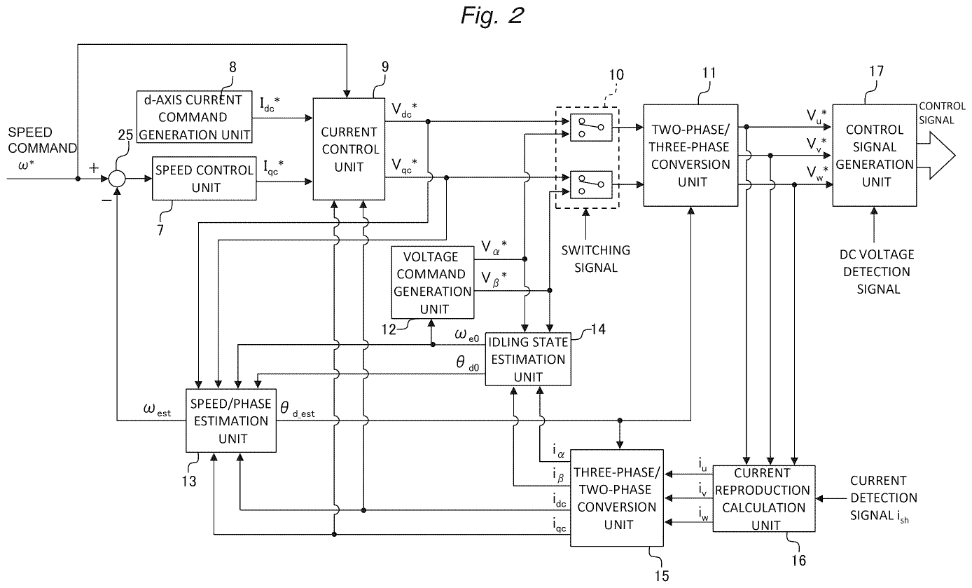

FIG. 2 is a functional block diagram illustrating processing details of the motor control device. As described above, the motor control device 4 is a semiconductor arithmetic device such as a microcomputer or a DSP, and realizes each function by executing a predetermined program.

As illustrated in FIG. 2, the motor control device 4 includes a speed control unit 7, a d-axis current command generation unit 8, a current control unit 9, a voltage command switching unit 10, a two-phase/three-phase conversion unit 11, a speed/phase estimation unit 13, a voltage command generation unit 12, an idling state estimation unit 14, a three-phase/two-phase conversion unit 15, a current reproduction calculation unit 16, and a control signal generation unit 17 (PWM controller).

The motor control device 4 calculates a voltage command to be applied to the permanent magnet synchronous motor 3 by d-q axis vector control, and generates a pulse width modulation (PWM) control signal of the inverter 2 based on the voltage command, thereby controlling the operation of the permanent magnet synchronous motor 3. The motor control device 4 performs operation control in a normal operating state (normal operation control) of the permanent magnet synchronous motor 3, and transition control from an idling state to a normal operating state (start-up control).

### <Normal Operation Control>

First, the operation of each functional block during the operation control in the normal operating state will be described.

The current reproduction calculation unit 16 reproduces three-phase motor currents iu, iv, and iw from the inverter 2 using a current detection signal ish output from the amplifier 6 constituting the DC current detector and three-phase voltage commands Vu*, Vv*, and Vw* output from the two-phase/three-phase conversion unit 11 to the control signal generation unit 17. A known method may be used as a method of reproducing the three-phase motor currents from the current signal of the shunt resistor 5, and a detailed description thereof will be omitted here.

In the present embodiment, in order to reduce the cost, the current reproduction calculation unit 16 reproduces the three-phase motor currents iu, iv, and iw from the current detection signal ish detected by the shunt resistor 5 and inputs the three-phase motor currents iu, iv, and iw to the three-phase/two-phase conversion unit 15, but the present invention is not limited thereto. For example, instead of the shunt resistor 5, a current detection means such as a current sensor may be used to detect an AC current, which is an output of the inverter 2, and three-phase motor currents iu, iv, and iw detected by the current detection means may be input to the three-phase/two-phase conversion unit 15.

Based on the three-phase output currents iu, iv, and iw reproduced by the current reproduction calculation unit 16 and phase information θd_est estimated by the speed/phase estimation unit 13, the three-phase/two-phase conversion unit 15 calculates an α-axis current iα, a β-axis current iβ, a dc-axis current idc, and a qc-axis current iqc based on the following (Formula 1) and (Formula 2). Note that the following (Formula 1) represents so-called three-phase/two-phase conversion, and (Formula 2) represents conversion into a rotating coordinate system.

$$[ Math . 1 ]$$

$$( \begin{matrix}{i}_{α} \\ {i}_{β}\end{matrix} ) = \frac{2}{3} ( \begin{matrix}cos ( 0 ) & cos ( 2 π / 3 ) & cos ( 4 π / 3 ) \\ sin ( 0 ) & sin ( 2 π / 3 ) & sin ( 4 π / 3 )\end{matrix} ) ( \begin{matrix}{i}_{u} \\ {i}_{v} \\ {i}_{w}\end{matrix} ) \qquad ( Formula 1 )$$

$$[ Math . 2 ]$$

$$( \begin{matrix}{i}_{dc} \\ {i}_{qc}\end{matrix} ) = ( \begin{matrix}cos ( {θ}_{d \_ est} ) & sin ( {θ}_{d \_ est} ) \\ - sin ( {θ}_{d \_ est} ) & cos ( {θ}_{d \_ est} )\end{matrix} ) ( \begin{matrix}{i}_{α} \\ {i}_{β}\end{matrix} ) \qquad ( Formula 2 )$$

The dc-qc axis is an estimated axis of the vector control system based on estimated position information, and the d-q axis is a motor rotor axis. Here, an axis error between the d-q axis and the dc-qc axis is defined as Δθc.

The speed/phase estimation unit 13 estimates a position and a rotation speed of the rotor using the dc-axis current detection value idc and the qc-axis current detection value iqc, and dc-qc axis voltage commands Vdc* and Vqc*, and outputs the estimated position and rotation speed as phase information θd_est and an estimated speed west. Note that a known means may be used as a specific estimation means for the speed/phase estimation unit 13, and a detailed description thereof will be omitted here.

The speed control unit 7 creates a qc-axis current command value Iqc* so that a deviation calculated by a calculation unit 25 from a speed command value ω* generated by a functional unit (not illustrated) in the motor control device 4 according to a command from the outside and the estimated speed west estimated by the speed/phase estimation unit 13 approaches 0 (zero), that is, so that the estimated speed west approaches the speed command value ω*.

The d-axis current command generation unit 8 generates a dc-axis current command value Idc* for minimizing the three-phase motor currents iu, iv, and iw.

The current control unit 9 calculates and outputs a dc-axis voltage command value Vdc* and a qc-axis voltage command value Vqc* by using the dc-axis current command value Idc* provided from the d-axis current command generation unit 8, the qc-axis current command value Iqc* provided from the speed control unit 7, the dc-axis current detection value idc and the qc-axis current detection value iqc provided from the three-phase/two-phase conversion unit 15, the speed command value w*, and the motor constant.

The voltage command switching unit 10 outputs either the dc-qc axis voltage commands Vdc* and Vqc* calculated by the current control unit 9 and the α-axis voltage commands Vα* and Vβ* calculated by the voltage command generation unit 12 to the two-phase/three-phase conversion unit 11 based on a switching signal from the outside. Specifically, the voltage command switching unit 10 outputs the dc-qc axis voltage commands Vdc* and Vqc* calculated by the current control unit 9 based on the switching signal in the normal operating state to the two-phase/three-phase conversion unit 11. Note that the voltage command switching unit 10 outputs the α-β axis voltage commands Vα* and Vβ* calculated by the voltage command generation unit 12 based on the switching signal in the idling state (start-up control) to the two-phase/three-phase conversion unit 11.

In the normal operating state, the two-phase/three-phase conversion unit 11 calculates and outputs three-phase voltage commands Vu*, Vv*, and Vw* by the following (Formula 3) and (Formula 4) using the dc-qc axis voltage commands Vdc* and Vqc* calculated by the current control unit 9 and input via the voltage command switching unit 10 and the phase information θd_est from the speed/phase estimation unit 13. Note that the following (Formula 3) represents conversion from the rotating coordinate system to a fixed coordinate system, and the following (Formula 4) represents so-called two-phase/three-phase conversion.

$$[ Math . 3 ]$$

$$( \begin{matrix}{V}_{α}^{*} \\ {V}_{β}^{*}\end{matrix} ) ( \begin{matrix}cos ( {θ}_{d \_ est} ) & - sin ( {θ}_{d \_ est} ) \\ sin ( {θ}_{d \_ est} ) & cos ( {θ}_{d \_ est} )\end{matrix} ) ( \begin{matrix}{i}_{α} \\ {i}_{β}\end{matrix} ) \qquad ( Formula 3 )$$

$$[ Math . 4 ]$$

$$( \begin{matrix}{V}_{u}^{*} \\ {V}_{v}^{*} \\ {V}_{w}^{*}\end{matrix} ) = ( \begin{matrix}cos ( 0 ) & sin ( 0 ) \\ cos ( 2 π / 3 ) & sin ( 2 π / 3 ) \\ cos ( 4 π / 3 ) & sin ( 4 π / 3 )\end{matrix} ) ( \begin{matrix}{V}_{α}^{*} \\ {V}_{β}^{*}\end{matrix} ) \qquad ( Formula 4 )$$

The control signal generation unit 17 generates a control signal based on the three-phase voltage commands Vu*, Vv*, and Vw* from the two-phase/three-phase conversion unit 11 and the detection value (DC voltage detection signal) from the DC voltage detector 50, and outputs the control signal to the inverter 2.

### <Start-Up Control>

Next, the operation of each functional block during the transition control from the idling state to the normal operating state (start-up control) will be described. For the start-up control, only differences from the normal operating state will be described.

First, the basic principle of phase detection (estimating a position and a rotation speed of the rotor) in the idling state will be described.

When the permanent magnet synchronous motor 3 is to be restarted from the idling state without using information on the position and the rotation speed of the rotor, it may be difficult to start up the permanent magnet synchronous motor 3 under the normal operation control depending on the rotation speed of the permanent magnet synchronous motor 3. Therefore, in the present embodiment, a position and a rotation speed of the rotor are calculated in the idling state of the permanent magnet synchronous motor 3 and used for the start-up control.

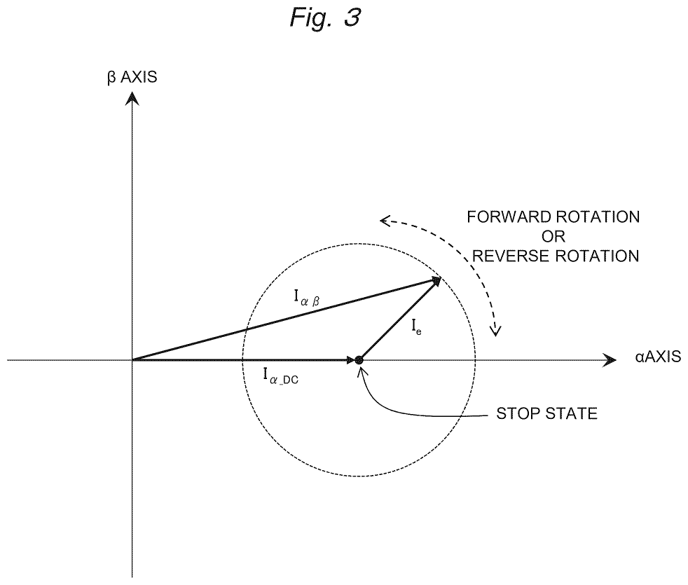

FIG. 3 is an explanatory diagram illustrating a current vector when a DC current flows through a permanent magnet synchronous motor.

In FIG. 3, when the permanent magnet synchronous motor 3 is not idling, a current Iα_DC corresponding to the DC current based on the α axis flows through the permanent magnet synchronous motor 3. In this case, the β-axis current Iβ becomes 0 (zero).

On the other hand, when the permanent magnet synchronous motor 3 is idling (in the idling state), a current Ie corresponding to the influence of the induced voltage is added to the current Iα_DC, and a current Iαβ (=Iα_DC+Ie) added as a vector flows through the permanent magnet synchronous motor 3. That is, as illustrated in FIG. 3, the phase angle of the current Iαβ changes according to the rotation speed and the rotation direction of the permanent magnet synchronous motor 3 in the idling state.

Therefore, in the present embodiment, a rotation speed and a rotational direction of the permanent magnet synchronous motor 3 in the idling state are estimated using the fact that the currents Ix and Iβ flowing through the permanent magnet synchronous motor 3 change according to the idling state.

In the present embodiment, a case where a DC current flows through one phase of the permanent magnet synchronous motor 3, which is a three-phase motor, will be described as an example, but a DC current may flow through a plurality of phases and a rotation speed and a rotation direction may be estimated for each phase.

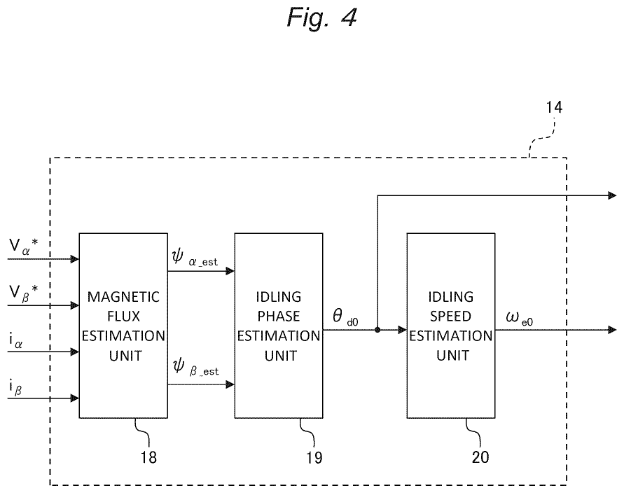

FIG. 4 is a functional block diagram illustrating processing details of the idling state estimation unit.

In FIG. 4, the idling state estimation unit 14 is a functional unit that calculates an initial phase θd0 as a position of the rotor and an initial speed ωe0 as a rotation speed of the permanent magnet synchronous motor 3 in the idling state, and outputs the initial phase θd0 and the initial speed ωe0 to the voltage command generation unit 12 and the speed/phase estimation unit 13, and includes a magnetic flux estimation unit 18, an idling phase estimation unit 19, and an idling speed estimation unit 20.

The magnetic flux estimation unit 18 calculates estimated magnetic fluxes Ψα_est and Ψβ_est by the following (Formula 5) and (Formula 6) using the α-β axis voltage commands Vα* and Vβ* calculated by the voltage command generation unit 12 and the α-β axis motor currents iα and iβ calculated by the three-phase/two-phase conversion unit 15, and outputs the estimated magnetic fluxes Ψα_est and Ψβ_est to the idling phase estimation unit 19. In (Formula 5) and (Formula 6), R is a motor winding resistance value, and Ψα (0) and Ψβ (0) are initial values of the estimated magnetic fluxes Ψα_est and Ψβ_est, respectively.

$$[ Math . 5 ]$$

$${Ψ}_{α\_ est} = \int ( {V}_{α}^{*} - {Ri}_{α} ) dt + {Ψ}_{α ( 0 )} \qquad ( Formula 5 )$$

$$[ Math . 6 ]$$

$${Ψ}_{β\_ est} = \int ( {V}_{β}^{*} - {Ri}_{β} ) dt + {Ψ}_{β ( 0 )} \qquad ( Formula 6 )$$

The idling phase estimation unit 19 calculates an initial phase θd0 by the following (Formula 7) using the estimated magnetic fluxes Ψα_est and Ψβ_est calculated by the magnetic flux estimation unit 18, outputs the initial phase θd0 to the idling speed estimation unit 20 and to the speed/phase estimation unit 13.

$$[ Math . 7 ]$$

$${θ}_{d 0} = {tan}^{- 1} ( {Ψ}_{β\_ est} / {Ψ}_{α\_ est} ) \qquad ( Formula 7 )$$

The idling speed estimation unit 20 calculates and outputs an initial speed ωe0 using the initial phase θd0 calculated by the idling phase estimation unit 19. Specifically, for example, an estimated speed west (=Δθd0/Δt) is calculated and output by dividing a difference Δ0d0 (θd0_2−θd0_1) between a previous value θd0_1 and a current value θd0_2 of the initial phase θd0 repeatedly calculated in a predetermined control cycle by a time Δt(=t2−t1) from time t1 at which the previous value θd0_1 is calculated to time t2 at which the current value θd0_2 is calculated.

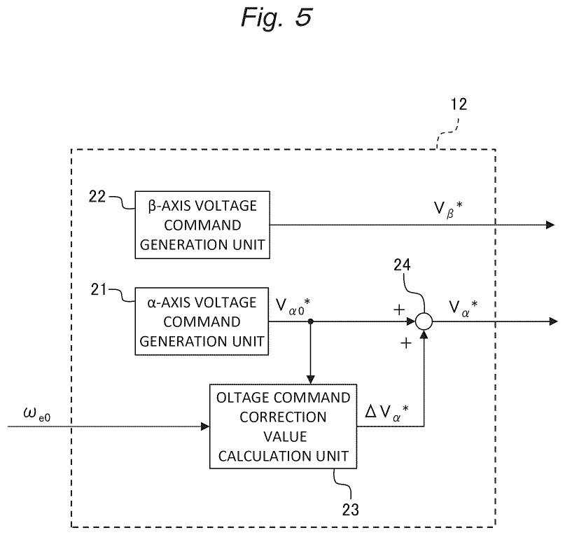

FIG. 5 is a functional block diagram illustrating processing details of the voltage command generation unit.

In FIG. 5, the voltage command generation unit 12 is a functional unit that calculates α-axis voltage commands Vα* and Vβ* necessary for controlling the permanent magnet synchronous motor 3 in the idling state and outputs the α-β axis voltage commands Vα* and Vβ* to the idling state estimation unit 14 and the voltage command switching unit 10 (in other words, the two-phase/three-phase conversion unit 11), and includes an α-axis voltage command generation unit 21, a β-axis voltage command generation unit 22, and a voltage command correction value calculation unit 23.

For example, the α-axis voltage command generation unit 21 obtains an α-axis voltage command value capable of estimating a maximum speed (e.g., a speed expected during low-speed operation) of the permanent magnet synchronous motor 3 assumed to be in the idling state by calculation or experiment, and outputs the obtained α-axis voltage command value as an initial α-axis voltage command value Vα0*.

The β-axis voltage command generation unit 22 sets, for example, 0 (zero) as a β-axis voltage command value in the voltage command Vβ* and outputs the voltage command Vβ*.

The voltage command correction value calculation unit 23 calculates a voltage command correction value ΔVα*, for example, based on the following (Formula 8), (Formula 9), and (Formula 10), using the initial speed ωe0 calculated by the idling speed estimation unit 20 of the idling state estimation unit 14 and the voltage command Vα0*, which is an output of the α-axis voltage command generation unit 21. In (Formula 8), Ke is an induced voltage constant of the permanent magnet synchronous motor 3, and Eest is an estimated induced voltage. In (Formula 9), ΔVVα0_E is a deviation between the estimated induced voltage Eest and the initial α-axis voltage command value Vα0*. In (Formula 10), VCO is a correction amount for making the α-axis voltage command Vα* larger than the estimated induced voltage Eest, and is obtained by calculation or experiment and set in advance.

$$[ Math . 8 ]$$

$${E}_{Est} = {ω}_{e 0} {K}_{e} \qquad ( Formula 8 )$$

$$[ Math . 9 ]$$

$$Δ {V}_{Va 0 \_ E} = {V}_{α 0}^{*} - {E}_{est} \qquad ( Formula 9 )$$

$$[ Math . 10 ]$$

$$Δ {V}_{α}^{*} = {V}_{CO} - Δ {V}_{Va 0 \_ E} \qquad ( Formula 10 )$$

The calculation unit 24 calculates an α-axis voltage command Vα*, which is an output of the voltage command generation unit 12, based on the following (Formula 11), using the voltage command Vα0*, which is an output of the α-axis voltage command generation unit 21, and the voltage command correction value ΔVα*.

$$[ Math . 11 ]$$

$${V}_{α}^{*} = {V}_{α 0}^{*} + Δ {V}_{α}^{*} \qquad ( Formula 11 )$$

The speed/phase estimation unit 13 sets the initial speed ωe0 from the idling speed estimation unit 20 of the idling state estimation unit 14 and the initial phase θd0 of the motor rotor from the idling phase estimation unit 19 to initial values, and performs transition control from the idling state to the normal operating state of the permanent magnet synchronous motor 3 (start-up control).

The voltage command switching unit 10 outputs the α-β axis voltage commands Vα* and Vβ* calculated by the voltage command generation unit 12 based on the switching signal from the outside in the idling state (start-up control) to the two-phase/three-phase conversion unit 11.

In the idling state (start-up control), the speed control unit 7 creates a qc-axis current command value Iqc* so that a deviation between a speed command value ω* generated by a functional unit (not illustrated) in the motor control device 4 according to a command from the outside and the estimated speed west (=ωe0 (initial value)) from the speed/phase estimation unit 13 approaches 0 (zero), that is, so that the estimated speed west approaches the speed command value ω*.

In the idling state (start-up control), the two-phase/three-phase conversion unit 11 calculates and outputs three-phase voltage commands Vu*, Vv*, and Vw* by (Formula 3) and (Formula 4) using the α-β axis voltage commands Vα* and Vβ* calculated by the voltage command generation unit 12 and input via the voltage command switching unit 10 and the phase information θd_est (=θd0 (initial value)) from the speed/phase estimation unit 13.

The effects of the present embodiment configured as described above will be described.

In the conventional technique, since the short-circuit current of the motor winding during the short-circuit operation of the inverter is determined by the motor induced voltage, the winding resistance, and the inductance, an overcurrent may occur during the short-circuit operation depending on the idling speed. In addition, since a special PWM control mode and current detection processing are used by detecting a current flowing through the bus (shunt) resistor, computation for calculating a position and a rotation speed of the rotor of the motor is complicated, and an error is likely to occur in the estimation result.

In contrast, in the present embodiment, a motor control device that controls an operation of a permanent magnet synchronous motor by controlling an operation of an inverter that converts DC power into AC power and supplies the AC power to the permanent magnet synchronous motor according to a control signal based on a voltage command includes: a first control unit that generates a control signal of the inverter when the permanent magnet synchronous motor is normally operating; and a second control unit that generates a control signal of the inverter when the permanent magnet synchronous motor is idling, in which the second control unit is configured to: when the permanent magnet synchronous motor is in an idling state, output a voltage command for causing a DC current having a predetermined initial value to flow through the permanent magnet synchronous motor; calculate a position and a rotation speed of a rotor of the permanent magnet synchronous motor based on the voltage command and a current value of the permanent magnet synchronous motor corresponding to the voltage command; estimate an induced voltage of the permanent magnet synchronous motor based on the calculated rotation speed; and adjust the voltage command so as to be larger than the estimated induced voltage. Therefore, the position and the speed of the motor rotor can be calculated with higher accuracy.

### <Supplementary Note>

Note that the present invention is not limited to the above-described embodiment, and includes various modifications and combinations without departing from the gist of the present invention. In addition, the present invention is not limited to including all of the configurations described in the above embodiment, and some of the configurations may be deleted.

For example, in order to avoid the influence of disturbance and noise, the motor control device 4 may perform moving average processing or low-pass filter processing on values used for various calculations.

Further, the configurations, functions, and the like of the motor control device 4 described in the present embodiment may be realized by designing some or all of them, for example, as an integrated circuit. In addition, the above-described configurations, functions, and the like may be realized as software by the processor interpreting and executing programs for realizing the respective functions.

### REFERENCE SIGNS LIST

1 DC power supply
2 inverter
3 permanent magnet synchronous motor
4 motor control device
5 shunt resistor
6 amplifier
7 speed control unit
8 d-axis current command generation unit
9 current control unit
10 voltage command switching unit
11 two-phase/three-phase conversion unit
12 voltage command generation unit
13 speed/phase estimation unit
14 idling state estimation unit
15 three-phase/two-phase conversion unit
16 current reproduction calculation unit
17 control signal generation unit
18 magnetic flux estimation unit
19 idling phase estimation unit
20 idling speed estimation unit
21 α-axis voltage command generation unit
22 β-axis voltage command generation unit
23 voltage command correction value calculation unit
24, 25 calculation unit
50 DC voltage detector

1. A motor control device that controls an operation of a permanent magnet synchronous motor by controlling an operation of an inverter that converts DC power into AC power and supplies the AC power to the permanent magnet synchronous motor according to a control signal based on a voltage command, the motor control device comprising:
a first control unit that generates a control signal of the inverter when the permanent magnet synchronous motor is normally operating; and
a second control unit that generates a control signal of the inverter when the permanent magnet synchronous motor is idling,
wherein the second control unit is configured to:
when the permanent magnet synchronous motor is in an idling state,
output a voltage command for causing a DC current having a predetermined initial value to flow through the permanent magnet synchronous motor;
calculate a position and a rotation speed of a rotor of the permanent magnet synchronous motor based on the voltage command and a current value of the permanent magnet synchronous motor corresponding to the voltage command;
estimate an induced voltage of the permanent magnet synchronous motor based on the calculated rotation speed; and
adjust the voltage command so as to be larger than the estimated induced voltage.

2. The motor control device according to claim 1, wherein
the second control unit outputs a voltage command for causing the DC current having the initial value to flow through one phase among a plurality of phases included in an armature of the permanent magnet synchronous motor.

3. The motor control device according to claim 1, wherein
the DC current having the initial value is a current value that allows estimation of a speed expected when the permanent magnet synchronous motor is operating at a low speed.

4. The motor control device according to claim 1, wherein
the second control unit is configured to:
estimate the induced voltage based on a rotation speed and an induced voltage constant of the permanent magnet synchronous motor;
calculate a deviation between the induced voltage and the voltage command for causing the DC current having the initial value to flow;
calculate a difference between a predetermined correction value and the deviation as a voltage command correction value; and
adjust the voltage command by adding the voltage command correction value to the voltage command for causing the DC current having the initial value to flow.

5. A motor control method for controlling an operation of a permanent magnet synchronous motor by controlling an operation of an inverter that converts DC power into AC power and supplies the AC power to the permanent magnet synchronous motor according to a control signal based on a voltage command, the motor control method comprising:
outputting a voltage command for causing a DC current having a predetermined initial value to flow through the permanent magnet synchronous motor when the permanent magnet synchronous motor is in an idling state;
calculating a position and a rotation speed of a rotor of the permanent magnet synchronous motor based on the voltage command and a current value of the permanent magnet synchronous motor corresponding to the voltage command;
estimating an induced voltage of the permanent magnet synchronous motor based on the calculated rotation speed; and
adjusting the voltage command so as to be larger than the estimated induced voltage.
